(19) United States
(12) Patent Application Publication
(10) Pub. No.: US 2007/0180148 A1
(43) Pub. Date: Aug. 2, 2007

(54) Method and apparatus for creating scalable hi-fidelity HTML forms

(75) Inventor: Farzad Yadidian, Beverly Hills, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Multimedia Abacus Corporation, Inglewood, CA (US)

(21) Appl. No.: 11/346,967

(22) Filed: Feb. 2, 2006

(51) Int. Cl. G06F 15/16

(52) U.S. Cl. 709/246

(57) ABSTRACT

A computer readable medium having instructions stored thereon for causing a computer to execute a method for reproducing an electronic form page on a Web browser, the Web browser having a graphical user interface (GUI) window displayable at a first resolution, the method including receiving a request for the electronic form page; generating an image of the electronic form page at the first resolution; and, translating the properties for at least one field in the electronic form page to create a Web browser native version of the field. A method and an apparatus for performing the method are also disclosed.

### BACKGROUND

1. Field

The present invention relates generally to electronic forms, and more particularly, to a method and apparatus for creating scalable hi-fidelity HTML forms.

2. Background

Within the past few years, the electronic forms and document management industry has been witness to the large-scale adoption of What-You-See-Is-What-You-Get (WYSIWYG) electronic forms by organizations both in the government and the private sector as a means of moving away from antiquated paper systems. These electronic form systems are typically network-based, where, for example, a server computer on a network hosts one or more electronic forms. A user, using a client computer coupled to the server computer through a network such as the Internet, or World-Wide-Web (Web), can download one of these electronic forms and submit the information requested therein to the server computer. The server computer stores the data retrieved using the electronic form into a database. The data stored in the database may then later be retrieved and, for example, displayed using the same electronic form, or, in another example, used in a report.

The retrieval and display of these electronic forms have generally been accomplished by applications developed around client-side form engines that provide for the rendering of and interaction with electronic forms. These “client-side” applications are installed on a client computer after the applications are either downloaded from a server computer or retrieved from a computer data storage medium. The client-side applications are responsible for rendering (i.e., displaying) the forms on the client computer, validating the data provided by a user filling out the electronic form and transmitting the gathered data to the server computer. The need for large-scale implementation of these network-based electronic form along with the desire to minimize the cost overhead and other issues associated with installing and updating client-side applications and form engines has precipitated the need for a system capable of rendering high-fidelity WYSIWYG forms via software that is as ubiquitous as Internet browser software, which is typically found as a part of the software package installed in all computer system today.

Although the evolution of Hyper-Text Markup Language (HTML) and complimentary technologies such as Cascading Style Sheets (CSS) have made composition of near-WYSIWYG forms possible, HTML form designers are still not able to create pixel-perfect WYSIWYG electronic forms that closely mimic their paper counterparts. To make matters more complicated, functionalities that are intrinsic to client-side form engines, such as zooming and dynamic bar-code generation (i.e., dynamic generation of bar-codes based on the data being input on the form), are fairly difficult to implement in traditional HTML forms.

### SUMMARY

A method for reproducing a high-fidelity electronic form page on a Web browser in accordance with one preferred embodiment is described herein. The method including the steps of receiving a request for the electronic form page; generating an image of the electronic form page; and, translating the properties for at least one field in the electronic form page to create a Web browser native version of the field; wherein when the Web browser native version of the field and the image is displayed on the Web browser to create a rendered form, the rendered form is a close equivalent of the electronic form page.

A computer readable medium having instructions stored thereon for causing a computer to execute a method for reproducing a high-fidelity electronic form page on a Web browser in accordance with one preferred embodiment is also described herein, the method including receiving a request for the electronic form page; generating an image of the electronic form page; and, translating the properties for at least one field in the electronic form page to create a Web browser native version of the field; wherein when the Web browser native version of the field and the image is displayed on the Web browser to create a rendered form, the rendered form is a close equivalent of the electronic form page.

An apparatus for reproducing a high-fidelity electronic form page on a Web browser in accordance with one preferred embodiment is also described herein. The apparatus having means for receiving a request for the electronic form page; means for generating an image of the electronic form page; and, means for translating the properties for at least one field in the electronic form page to create a Web browser native version of the field. Wherein when the Web browser native version of the field and the image is displayed on the Web browser to create a rendered form, the rendered form is a close equivalent of the electronic form page.

A method for reproducing an electronic form page on a Web browser, the Web browser having a graphical user interface (GUI) window displayable at a first resolution, including receiving a request for the electronic form page; generating an image of the electronic form page at the first resolution; and, translating the properties for at least one field in the electronic form page to create a Web browser native version of the field.

A computer readable medium having instructions stored thereon for causing a computer to execute a method for reproducing an electronic form page on a Web browser, the Web browser having a graphical user interface (GUI) window displayable at a first resolution, the method including receiving a request for the electronic form page; generating an image of the electronic form page at the first resolution; and, translating the properties for at least one field in the electronic form page to create a Web browser native version of the field.

An apparatus for reproducing an electronic form page on a Web browser, the Web browser having a graphical user interface (GUI) window displayable at a first resolution, including means for receiving a request for the electronic form page; means for generating an image of the electronic form page at the first resolution; and, means for translating the properties for at least one field in the electronic form page to create a Web browser native version of the field.

Other objects, features and advantages will become apparent to those skilled in the art from the following detailed description. It is to be understood, however, that the detailed description and specific examples, while indicating exemplary embodiments, are given by way of illustration and not limitation. Many changes and modifications within the scope of the following description may be made without departing from the spirit thereof, and the description should be understood to include all such variations.

### BRIEF DESCRIPTION OF THE DRAWINGS

The invention may be more readily understood by referring to the accompanying drawings in which:

FIG. 1 is a block diagram of a computer system usable in the system, configured in accordance with one embodiment of a scalable hi-fidelity form generation system;

FIG. 2 is a network diagram illustrating a network of computer systems, configured in accordance with one preferred embodiment of the scalable hi-fidelity form generation system;

FIG. 3 is a flow diagram describing an operation of the scalable hi-fidelity form generation system in accordance with one preferred embodiment of the scalable hi-fidelity form generation system;

FIG. 4 is a graphical user interface of a screen showing a background image for an electronic form, configured in accordance with one preferred embodiment of the scalable hi-fidelity form generation system;

FIG. 5 is a graphical user interface of a screen showing a plurality of fields for the form of FIG. 4, configured in accordance with one preferred embodiment of the scalable hi-fidelity form generation system; and,

FIG. 6 is a graphical user interface of a screen showing the plurality of fields for the form from FIG. 5 overlaid on the background image for the form from FIG. 4, configured in accordance with one preferred embodiment of the scalable hi-fidelity form generation system.

FIG. 7 is a graphical user interface of a screen showing a plurality of fields for a second form overlaid on a background image for the second form, configured in accordance with one preferred embodiment of the scalable hi-fidelity form generation system.

Like numerals refer to like parts throughout the several views of the drawings.

### DETAILED DESCRIPTION

The method and apparatus described herein provides for creating scalable hi-fidelity Hyper-Text Markup Language (HTML) What-You-See-Is-What-You-Get (WYSIWYG) electronic form rendering and functionality on a client computer without any dependency on specialized client-side software applications or components such as electronic form generation engines. For example, the electronic form rendering and functionality provided herein is achieved using software that is already installed on the client computer such as an Internet browser. Furthermore, as will be explained herein, functionalities such as zooming and dynamic barcode generation may be easily integrated into the turnkey application built on top of the proposed design methodology.

In one preferred embodiment, a scalable hi-fidelity form template form is created from the creation of: (1) a background image, referred to as a form template, that is static in nature; and combining it with (2) one or more fillable form fields that are dynamic in nature. From the perspective of WYSIWYG rendering, the form template, which is the complicated/non-trivial component of the form, will be presented in raster/bitmap format and as an HTML background while the fillable fields will be presented as simple HTML fields with appropriate attributes overlaid on top of the form template.

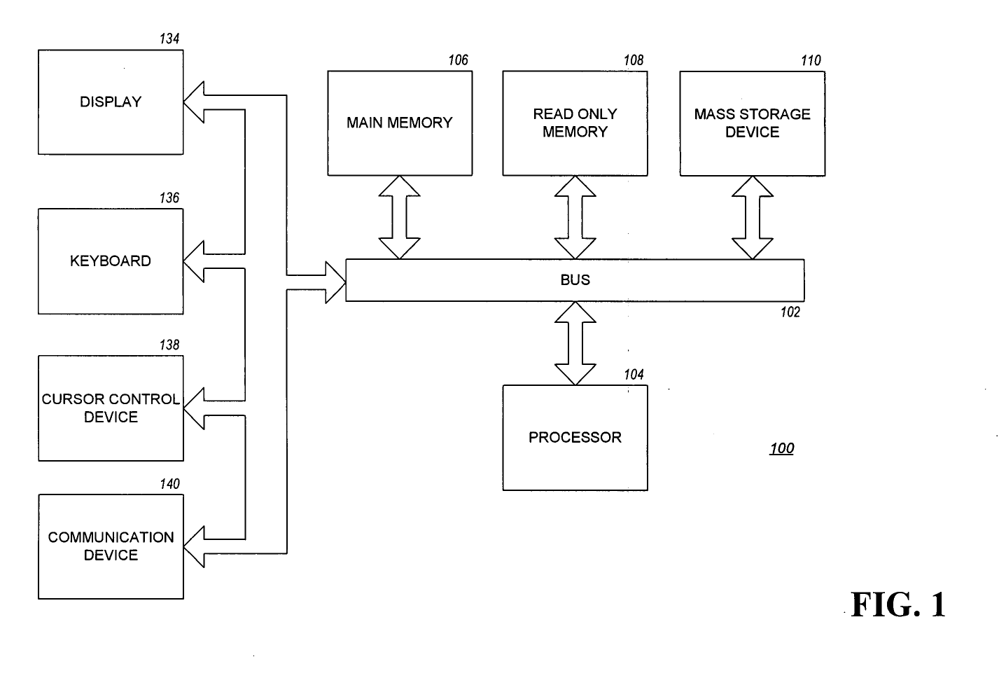

FIG. 1 illustrates an example of a computer system 100 in which the features of the present invention may be implemented. Computer system 100 includes a bus 102 for communicating information between the components in computer system 100, and a processor 104 coupled with bus 102 for executing software code, or instructions, and processing information. Computer system 100 further comprises a main memory 106, which may be implemented using random access memory (RAM) and/or other random memory storage device, coupled to bus 102 for storing information and instructions to be executed by processor 104. Main memory 106 also may be used for storing temporary variables or other intermediate information during execution of instructions by processor 104. Computer system 100 also includes a read only memory (ROM) 108 and/or other static storage device coupled to bus 102 for storing static information and instructions for processor 104.

Further, a mass storage device 110, such as a magnetic disk drive and/or a optical disk drive, may be coupled to computer system 100 for storing information and instructions. Computer system 100 can also be coupled via bus 102 to a display device 134, such as a cathode ray tube (CRT) or a liquid crystal display (LCD), for displaying information to a user so that, for example, graphical or textual information may be presented to the user on display device 134. Typically, an alphanumeric input device 136, including alphanumeric and other keys, is coupled to bus 102 for communicating information and/or user commands to processor 104. Another type of user input device shown in the figure is a cursor control device 138, such as a conventional mouse, touch mouse, trackball, track pad or other type of cursor direction key for communicating direction information and command selection to processor 104 and for controlling movement of a cursor on display 134. Various types of input devices, including, but not limited to, the input devices described herein unless otherwise noted, allow the user to provide command or input to computer system 100. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 100 may optionally include such devices as a video camera, speakers, a sound card, or many other conventional computer peripheral options.

A communication device 140 is also coupled to bus 102 for accessing other computer systems, as described below. Communication device 140 may include a modem, a network interface card, or other well-known interface devices, such as those used for interfacing with Ethernet, Token-ring, or other types of networks. In this manner, computer system 100 may be coupled to a number of other computer systems.

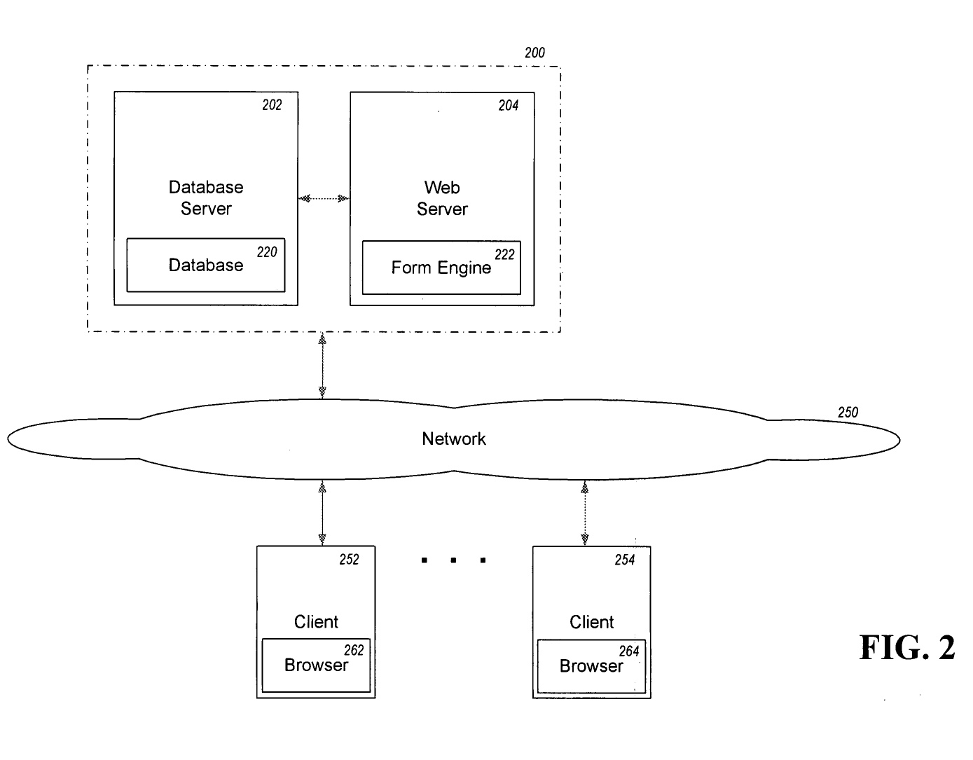

FIG. 2 illustrates a system in which the present system may be implemented, including a server system 200 having a database server 202 for hosting a database 220 and a web server 204 having a form engine 222. A client 252 and a client 254, is coupled for communications with server system 200 through a network 250. As described herein, a user, using software on a client computer such as a browser 262 on client 252 or a browser 264 on client 254, interacts with server system 200. Multiple server systems and clients, as well as other computer systems may also be coupled to server system 200. Also, form engine 222 interacts with other application software on web server 204 and database server 202 to perform the electronic form generation functionality as described herein, including receiving requests for electronic forms from client computers, generating and transmitting the necessary information for rendering the electronic forms on client computers, and receiving the results therefrom. Form engine 222 further accesses and presents the information from, as well as store information into, database 220. The information stored in database 220 is, in one preferred embodiment, information that is related to the electronic forms.

In the illustrated embodiment, network 250 represents a variety of networks that may include one or more local area networks as well as wide area networks. The functionality provided by database server 202, web server 204, client 252 and client 254, as well as by any other computer systems necessary in the scalable hi-fidelity form system, may be implemented using a computer system having the characteristics of the computer system 100 described herein. It should be noted, however, that the specific implementation of the computer system or systems used to describe the present invention is not to be limiting unless otherwise specifically noted. For example, the functionality provided by database server 202 and web server 204 may be combined in one computer system. Further, the functionality provided by database server 202 and web server 204 may be distributed over several computer systems.

As described herein, the user may interact with the information stored in server system 200 through browser software. The browser presents a graphical user interface (GUI) to the user. In the following description, the GUI is implemented using one or more web pages (which may be referred to as “pages,” “screens,” or “forms”) provided by web server 204 accessible by the user using any Internet web browser software, such as the Internet Explorer™ browser provided by Microsoft Corp., on client computer such as client 252. In another embodiment, one or more custom software programs can be created to implement the system described herein. Of course, web server 204 may itself have browser software installed on it so as to be accessed by a user. Further, throughout the description of the various embodiments of the invention herein, references are made to the user performing such actions as selecting buttons, inputting information on forms, executing searches or updates on the database 220. In one preferred embodiment, these actions are generated by the user during the user's interaction with the browser. For example, one or more pages described herein are electronic forms that include fields in which the user may type. Once the user has provided such data, the user may select a button or link on the page to submit the information and cause an update of the database 220 with the information. The browser will send web server 204 the information retrieved from the user using the electronic form, which will cause database 220 to be updated.

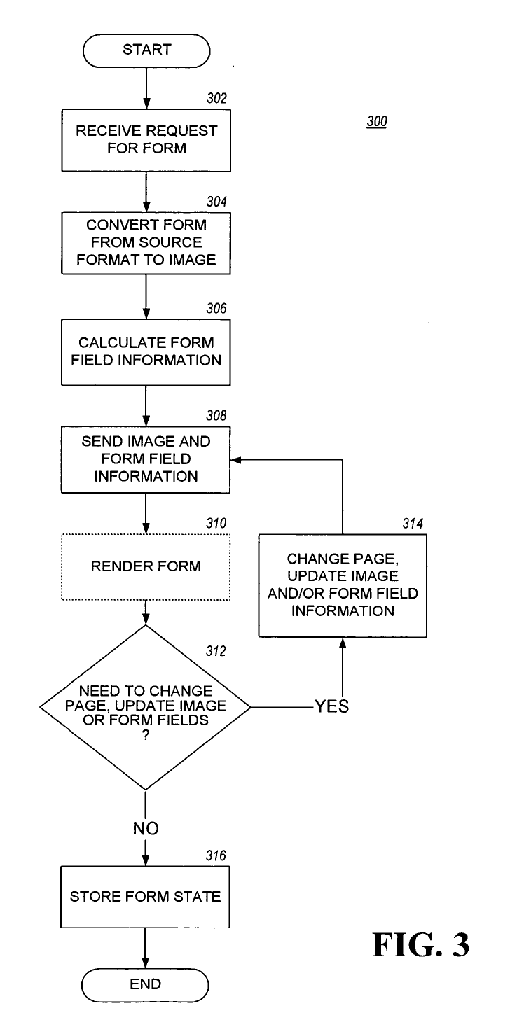

The following description is an exemplary operation of the system where a user, using browser 262 on client 252, interacts with server system 200 to request an electronic form, referred to herein as a source form. In one preferred embodiment, the request is for an individual page of an electronic form. In another preferred embodiment, the request may contain a request for multiple pages of the electronic form. Each form-page request from the client-side software (e.g., the browser) to the server application will be serviced by server system 200 (e.g., form engine 222), in accordance with the flow diagram as illustrated in FIG. 3, where, in step 302, browser 262 sends the information needed to render the electronic form, such as: the requested page number; the width of the graphical window that is currently being displayed, referred to as the Window-Width; the level of zoom (e.g. page-width, 100%, 200%, etc.), referred to as the Zoom-Level; and if applicable, the previous page's form-data so it could be later used for possible inter-page calculation requirements or for possible committing of the form data on all pages to database 220, as described below, to form engine 222.

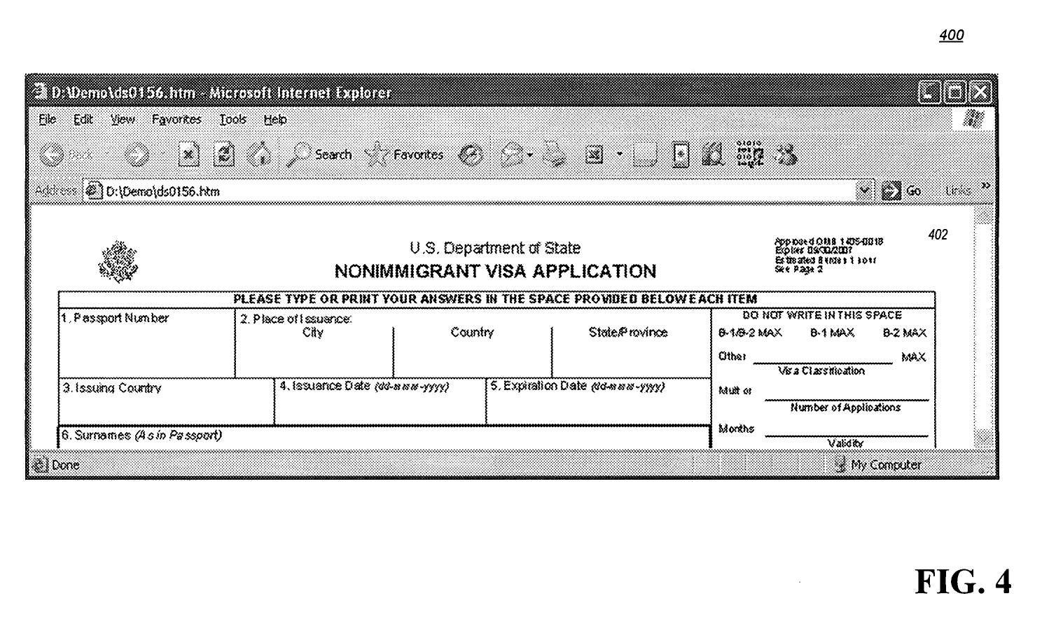

In step 304, form engine 222 converts the requested page from the source form, which is in vector format, to a raster/bitmap image that targets the environment of browser 262. The vector format of the electronic form, in one preferred embodiment, includes such formats as the PDF format from Adobe Systems Incorporated and the FAR format from Multimedia Abacus Corporation. It should be noted that the source form may include portions that are raster/bitmap images. The raster/bitmap image format, in one preferred embodiment, includes such formats as the Joint Photographic Experts Group (JPEG) and the Graphics Interchange Format (GIF) because these formats are universally supported by all commercial browsers. In one preferred embodiment, the resolution of the raster image will be dependant on the requested zoom level and the width of the browser window. For example, in case of a zoom level that is to be the width of the page, the width of the image will be set to the same value as the window width; for a zoom level of 100%, the target width of the bitmap image will be calculated based on a resolution of 100 dots per inch (DPI); for a zoom level of 200%, the width if the image will be calculated based on a 200 DPI resolution (e.g. a page width of 8.5″ inches will be translated to 1700 pixels). Other zoom levels are calculated in a similar fashion. The generated image will be set as the background of the HTML page returned to browser 262 in response to the form-page request. An exemplary background image 402, as displayed in a browser window 400, is shown in FIG. 4.

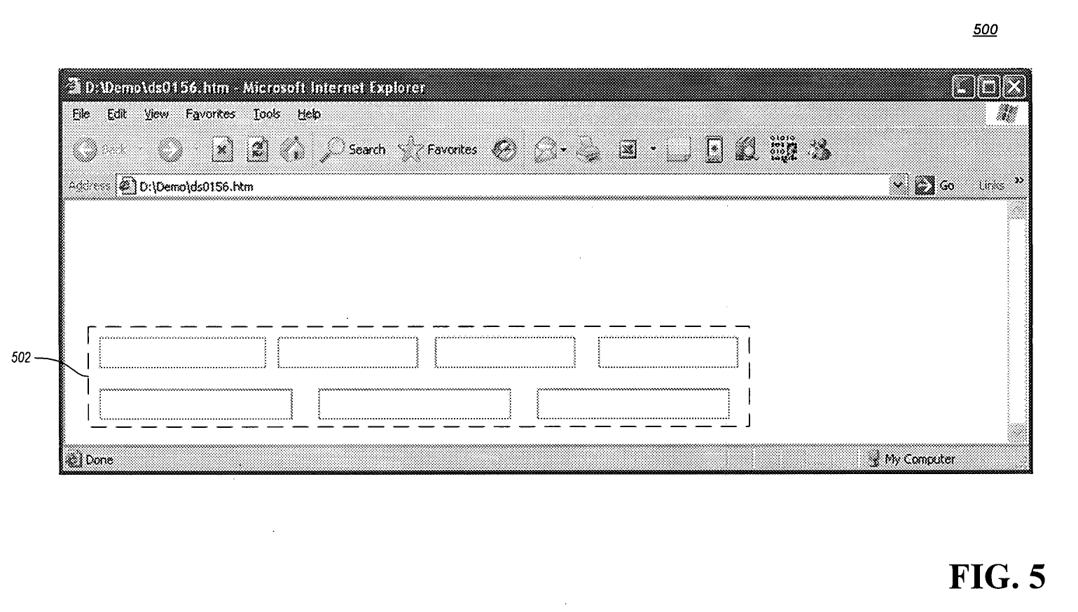

In step 306, form engine 222 iterates through all fillable fields on the requested page of the source form and, for each tillable field, generates the code necessary to create a field on the HTML page on browser 262 with appropriate attributes as they correspond to the original attributes of the object on the source form. For example, attributes of the fields include such attributes as field position, calculation logic, and data type. In one embodiment, the position of the fields on the HTML page will be in absolute-pixel mode and are computed based on the original position of the field on the source form and the current image-width and requested level of zoom. An example of a plurality of fields 502 that is displayed on a web page is shown in FIG. 5. For example, a fillable field at the inch-position (Left=0.32″, Top=1.24″, Width=1.52″, Height=0.28″) in source form with requested Zoom-Level of 100% will be translated to the following pixel-position on the generated HTML page: (Left=32, Top=124, Width=152, Height=28). For fields containing calculation logic, the calculation script should be translated to ECMAScript (i.e. client-side JavaScript for HTML pages as standardized by TC39 committee of ECMA standards organization). Intra-page calculation dependencies (e.g. field ‘X’ on page 1 being calculated off of the value of field ‘Y’ on page 1) can be completely processed on browser 262 whereas inter-page calculation dependencies, where a calculation for one field (e.g., field ‘X’ on page 2) is being calculated off of the value of another field on another page (e.g., field ‘Y’ on page 1) will require a communication from browser 262 to form engine 222 and back for proper handling, as described below.

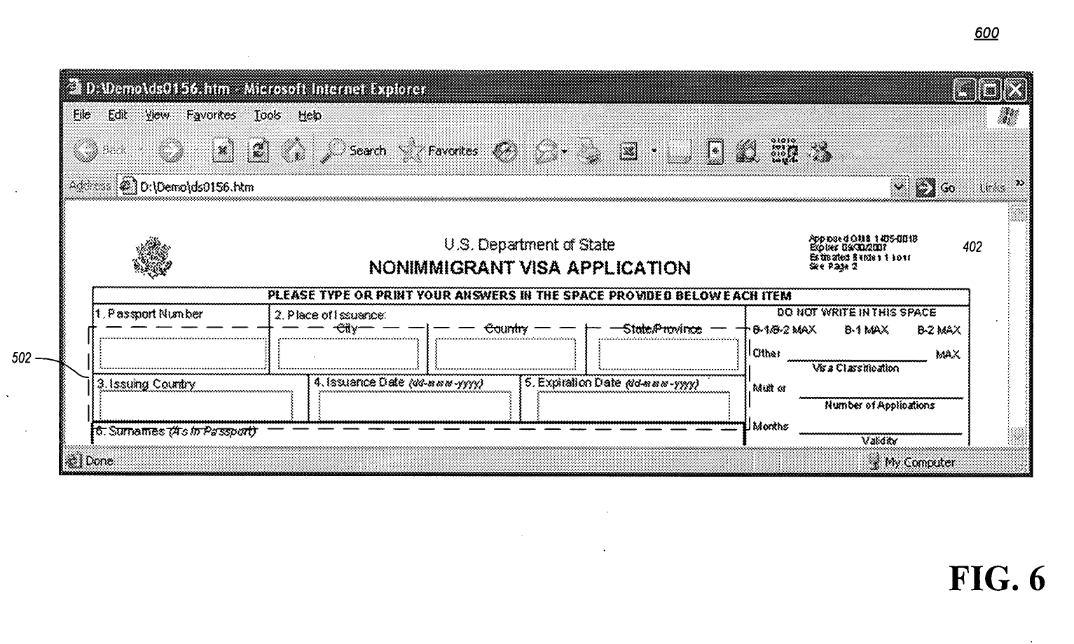

In step 308, the form field information and the image is sent to the browser for rending so that, in step 310, the browser renders the form by displaying the form fields using the form field information from step 304 over the background image generated in step 306. An example of a rendered form displayed as a Web page is shown in FIG. 6, where plurality of fields 502 is displayed in the appropriate positions on background image 402.

In step 312, it is determined if there is a need to update either the image or the information for one or more of the form fields. In one preferred embodiment, as discussed above, one reason for updating the form field information on the server side is for inter-page calculation dependencies. A second reason for updating the image is for the generation of graphic elements that are dependent on the information contained in the fields on the page being rendered, referred to as data dependant graphic elements. If it is determined that there is a need to update either the image or one or more of the form fields, operation continues with optional step 314. Otherwise, operation continues with step 316.

In step 314, the image and/or the form field information is updated as determined necessary in step 312. In one preferred embodiment, the implementation of the image generation logic will be a reverse of the logic described above for field calculation. For example, one data dependant graphic element type is a barcode image, referred to as a dynamic barcode, that is dynamically generated from the information contained on the electronic form. The barcode may be a coded version of all the information filled out by the user on the currently rendered page in the electronic form, and, thus, when the user updates a field, the portion of the image that includes the barcode to be updated has to be changed. In other words, if the affected dynamically generated barcode is on the same rendered page as the field currently being edited, the dynamic rendering will require the communication of the field information from browser 262 to form engine 222 to create a new background image. After the image and/or form field information has been updated, operation returns to step 308, where the updated image and/or form field information is transmitted to browser 262, and a new rendering of the electronic form on the current page is performed in step 308.

In step 316, the state of the form and its data is stored on server system 200. In one preferred embodiment, in addition to storing the state of a form and its data after it has been completed, each page change request will force a posting of the current page's state and data to the server system 200.

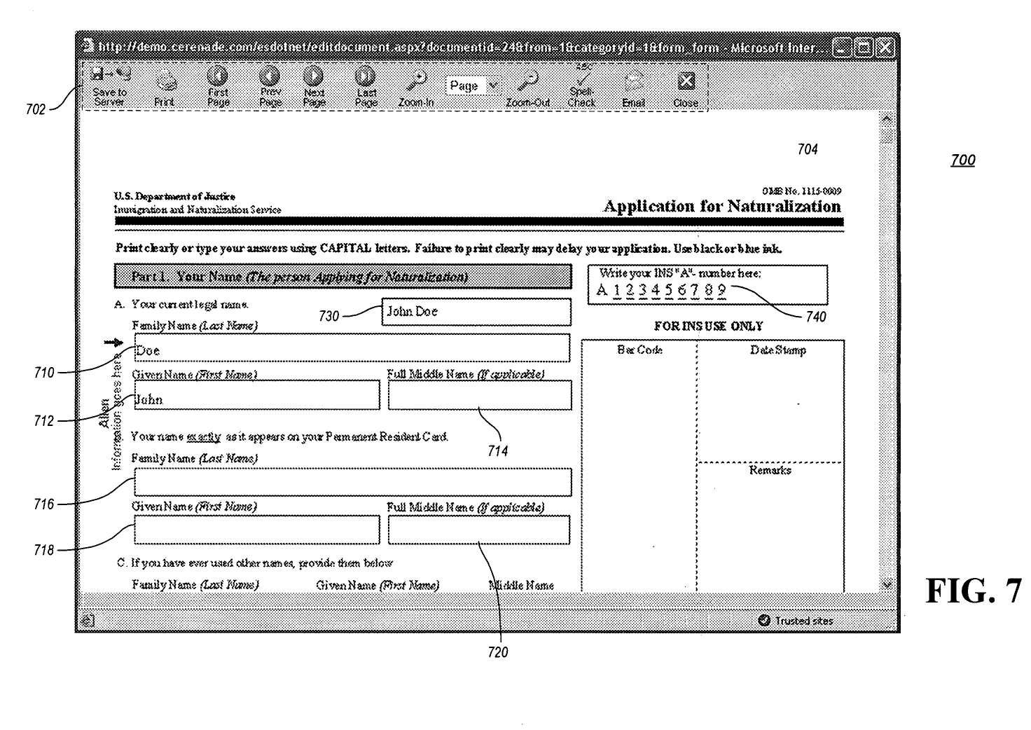

FIG. 7 is a graphical user interface of a Web browser window 700 showing a plurality of fields 710, 712, 714, 716, 718, 720, 730 and 740 for a second form overlaid on a background image 704 for the second form, configured in accordance with one preferred embodiment of the scalable hi-fidelity form generation system. Field 730 is an exemplary intra-page calculation field that is updated based on the values typed in by the user in fields 712, 710, and 712, respectively. Web browser window 700 also includes a toolbar 702 having buttons for saving the currently filled-in data to server system 200 (“Save to Server”); printing the form (“Print”); navigating to the first page of the second form (“First Page”); returning to a previous page (“Prev Page”); forwarding to a next page (“Next Page”); forwarding to the last page of the second form (“Last Page”); zooming in by increments (“Zoom-In”); zooming in at a preset zoom level (a pull-down menu currently displaying “Page”); zooming out by increments (“Zoom-Out”); checking the spelling of the values filled in the fields (“Spell-Check”); e-mailing a copy of the form (“Email”); and closing Web browser window 700 (“Close”).

In one preferred embodiment, the proposed implementation for WYSIWYG HTML Forms contained herein is primarily a web-based application, and adherence to the Asynchronous JavaScript and Extensible Markup Language (XML) (AJAX) Web application model is used to attempt to enhance a user's experience in relation to speed and responsiveness of the system. The asynchronous aspect of the AJAX application model will make a noticeable difference in the perceived performance of the system, particularly in rendering of the electronic form at high zoom level modes. Furthermore, in one preferred embodiment, the calculation dependencies between form fields, in addition to native script to JavaScript translation, can be done one-time only, then cached on the server and reused when new page requests are sent from the browser to the form engine. In one preferred embodiment, the calculation dependencies are serialized into a file that is placed into the same folder as the electronic form file.

It should be noted that the methods described herein may be implemented on a variety of hardware, processors and systems known by one of ordinary skill in the art. For example, the general requirement for a client (or server) computer to operate as described herein is that the computer has a display to display content and information, a processor to control the operation of the computer and a memory for storing data and programs related to the operation of the computer. In addition, the computer needs to have communication capability with other computers. The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a computer. In the alternative, the processor and the storage medium may reside as discrete components in a computer.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration”. Any embodiment described herein as “exemplary” is not necessarily to be construed as preferred or advantageous over other embodiments. Accordingly, the claimed invention is to be defined solely by the scope of the following claims.

What is claimed is:

1. A method for reproducing an electronic form page on a Web browser, the Web browser having a graphical user interface (GUI) window displayable at a first resolution, comprising:
receiving a request for the electronic form page;
generating an image of the electronic form page at the first resolution; and,
translating the properties for at least one field in the electronic form page to create a Web browser native version of the field.

2. The method of claim 1, wherein translating the properties for the at least one field in the electronic form page comprises locating all fields in the electronic form page.

3. The method of claim 1, wherein translating the properties for the at least one field in the electronic form page comprises creating an HTML equivalent field.

4. The method of claim 1, wherein receiving the request for the electronic form page includes receiving a zoom level.

5. The method of claim 1, wherein receiving the request for the electronic form page includes receiving a page number.

6. The method of claim 1, wherein receiving the request for the electronic form page includes receiving a window width.

7. The method of claim 1, wherein receiving the request for the electronic form page includes receiving form data.

8. The method of claim 1, wherein the image is a bitmapped image.

9. The method of claim 1, wherein generating the image of the electronic form page comprises generating a background image for a Web page.

10. The method of claim 9, wherein generating the background image for the Web page comprises generating HTML code for displaying the image as a background.

11. The method of claim 1, wherein generating the image of the electronic form page comprises generating a barcode image.

12. The method of claim 11, wherein generating the barcode image comprises:
retrieving data related to at least one field in the electronic form page; and, generating the barcode image based on the retrieved data.

13. The method of claim 12, wherein generating the barcode image further comprises updating the barcode image based on a detected change of any field in the electronic form page.

14. The method of claim 1, further comprising responding to the request with the image of the electronic form and the Web browser native version of the field.

15. The method of claim 1, further comprising superimposing the Web browser native version of the field on top of the image.

16. A computer readable medium having instructions stored thereon for causing a computer to execute a method for reproducing an electronic form page on a Web browser, the Web browser having a graphical user interface (GUI) window displayable at a first resolution, the method comprising:
receiving a request for the electronic form page;
generating an image of the electronic form page at the first resolution; and,
translating the properties for at least one field in the electronic form page to create a Web browser native version of the field.

17. The computer readable medium of claim 16, wherein translating the properties for the at least one field in the electronic form page comprises locating all fields in the electronic form page.

18. The computer readable medium of claim 16, wherein translating the properties for the at least one field in the electronic form page comprises creating an HTML equivalent field.

19. The computer readable medium of claim 16, wherein receiving the request for the electronic form page includes receiving a zoom level.

20. The computer readable medium of claim 16, wherein receiving the request for the electronic form page includes receiving a page number.

21. The computer readable medium of claim 16, wherein receiving the request for the electronic form page includes receiving a window width.

22. The computer readable medium of claim 16, wherein receiving the request for the electronic form page includes receiving form data.

23. The computer readable medium of claim 16, wherein the image is a bitmapped image.

24. The computer readable medium of claim 16, wherein generating the image of the electronic form page comprises generating a background image for a Web page.

25. The computer readable medium of claim 24, wherein generating the background image for the Web page comprises generating HTML code for displaying the image as a background.

26. The computer readable medium of claim 16, wherein generating the image of the electronic form page comprises generating a barcode image.

27. The computer readable medium of claim 26, wherein generating the barcode image comprises:
retrieving data related to at least one field in the electronic form page; and,
generating the barcode image based on the retrieved data.

28. The computer readable medium of claim 27, wherein the method further comprises updating the barcode image based on a detected change of any field in the electronic form page.

29. The computer readable medium of claim 16, wherein the method further comprises responding to the request with the image of the electronic form and the Web browser native version of the field.

30. The computer readable medium of claim 16, wherein the method further comprises superimposing the Web browser native version of the field on top of the image.

31. An apparatus for reproducing an electronic form page on a Web browser, the Web browser having a graphical user interface (GUI) window displayable at a first resolution, comprising:
means for receiving a request for the electronic form page;
means for generating an image of the electronic form page at the first resolution; and,
means for translating the properties for at least one field in the electronic form page to create a Web browser native version of the field.
